(19) United States
(12) Patent Application Publication
(10) Pub. No.: US 2026/0205020 A1
(43) Pub. Date: Jul. 16, 2026

(54) A MULTIPLE-OUTPUT RECTIFIER

(71) Applicant: EGGTRONIC ENGINEERING SPA, Modena (IT)

(72) Inventors: Igor SPINELLA, MODENA (IT); Lorenzo FERRARI, MODENA (IT)

(21) Appl. No.: 19/135,479

(22) PCT Filed: Dec. 7, 2023
(86) PCT No.: PCT/EP2023/084703

§ 371 Date: Jun. 4, 2025

(30) Foreign Application Priority Data
Dec. 7, 2022 (GB) 2218379.2

(51) Int. Cl. H02M 3/335; H02M 1/00; H02M 3/00; H02M 7/12

(52) U.S. Cl. CPC H02M 3/33576; H02M 1/0058; H02M 3/01; H02M 7/12

(57) ABSTRACT

It is disclosed a rectifier (100) comprising: a center-tapped transformer (105) having a secondary side winding (115) comprising a first terminal (135), a second terminal (140) and a central terminal (145), rectifier components (150, 165, 180, 195), and capacitors (230, 245), wherein the rectifier components include: a first rectifier component (150) having the anode (155) connected to the first terminal (135) of the secondary side winding (115) and the cathode (160) connected to a first output terminal (500) of the rectifier (100), a second rectifier component (165) having the anode (170) connected to a second output terminal (600) of the rectifier (100) and the cathode (175) connected to the second terminal (140) of the secondary side winding (115), a third rectifier component (180) having the anode (185) connected to a first common node (210) between the cathode (175) of the second rectifier component (165) and the second terminal (140) of the secondary side winding (115) and the cathode (190) connected to a second common node (215) between the cathode (160) of the first rectifier component (150) and the first output terminal (500) of the rectifier (100), a fourth rectifier component (195) having the anode (200) connected to a third common node (220) between the anode (170) of the second rectifier component (165) and the second output terminal (600) of the rectifier (100) and the cathode (205) connected to a fourth common node (225) between the anode (155) of the first rectifier component (150) and the first terminal (135) of the secondary side winding (115), and wherein the capacitors include: a first capacitor (230) having a first terminal (235) connected to the second common node (215) and a second terminal (240) connected to a fifth common node (260) between the central terminal (145) of the secondary side winding (115) and a third output terminal (550) of the rectifier (100), and a second capacitor (245) having a first terminal (250) connected to the fifth common node (260) and a second terminal (255) connected to third common node (220).

### BACKGROUND OF THE INVENTION

### 1. Field of the Invention

The present disclosure relates to a rectifier, namely to an electrical device designed to convert AC voltage into DC voltage.

### 2. Description of the Prior Art

Rectifiers are widely used, for example but not exclusively, in manufacturing isolated or non-isolated DC-DC converters.

Many of these DC-DC converters may indeed comprise a transformer having a primary side winding and a secondary side winding, a switching circuit coupled to the primary side winding and configured to convert an input direct voltage into a voltage wave, and a rectifier coupled to the secondary side winding to convert the voltage wave transferred by the transformer into an output direct voltage.

In this context, it is sometimes useful and/or necessary for a converter to generate multiple voltage outputs using a single transformer.

To achieve this, some techniques are known which generally involve equipping the transformer with a plurality of secondary side windings and to couple each of these secondary side windings to a dedicated rectifier, for example to a center-tap full wave rectifier, a full bridge rectifier or a voltage doubling rectifier.

However, these known techniques often suffer from poor cross-regulation, low secondary winding utilization, high stress, high cost, or high sensitivity to transformer construction tolerances.

### SUMMARY OF THE INVENTION

An object of the present disclosure is that of solving or at least of positively reducing one or more of the aforementioned drawbacks.

Another object of the present disclosure is that of reaching this goal with a simple, rational, and rather inexpensive solution.

These and other objects of the present disclosure are achieved by the embodiments of the disclosure as defined in the independent claims. The dependent claims define preferred or particularly advantageous aspects of the embodiments.

In particular, an embodiment of the disclosure provides a rectifier comprising:
a center-tapped transformer having a secondary side winding comprising a first terminal, a second terminal and a central terminal,
rectifier components, each of which comprises an anode, a cathode and is capable of allowing electric current to flow from the anode to the cathode while preventing a reverse flow of electric current from the cathode to the anode, and
capacitors,
wherein the rectifier components include:
a first rectifier component having the anode connected to the first terminal of the secondary side winding of the center-tapped transformer and the cathode connected to a first output terminal of the rectifier,
a second rectifier component having the anode connected to a second output terminal of the rectifier and the cathode connected to the second terminal of the secondary side winding of the center-tapped transformer,
a third rectifier component having the anode connected to a first common node between the cathode of the second rectifier component and the second terminal of the secondary side winding of the center-tapped transformer and the cathode connected to a second common node between the cathode of the first rectifier component and the first output terminal of the rectifier,
a fourth rectifier component having the anode connected to a third common node between the anode of the second rectifier component and the second output terminal of the rectifier and the cathode connected to a fourth common node between the anode of the first rectifier component and the first terminal of the secondary side winding of the center-tapped transformer, and wherein the capacitors include:
a first capacitor having a first terminal connected to the second common node and a second terminal connected to a fifth common node between the central terminal of the secondary side winding of the center-tapped transformer and a third output terminal of the rectifier, and
a second capacitor having a first terminal connected to the fifth common node and a second terminal connected to third common node.

As other multiple-output rectifiers, the novel rectifier outlined above is able to provide two voltage outputs or rails of different values, represented for example by the first output terminal and by the third output terminal.

However, with respect to known ones, the novel rectifier of the present disclosure entails several advantages.

For example, the novel rectifier generates two voltage outputs, one of which is substantially and/or consistently double of the other.

This is done using just one secondary winding (i.e. the secondary winding of the centertapped transformer), thereby simplifying the transformer, reducing its dimensions and increasing the efficiency of rectification.

Moreover, thanks to the novel rectifier topology, both halves of the secondary side winding are conducting current during every operation phase (i.e. both during positive and negative half cycles).

In practice, these two halves of the secondary side winding swap their role every half cycle.

In this way, the rectifier achieves at least one or more of the following:
maximum utilization of the secondary side winding of the transformer, e.g. to make the most effective use of the transformer's output
low sensitivity to transformer secondary unbalance, e.g. this reduces the risk of uneven stress and performance issues due to unbalanced load and
low harmonic stress in the secondary side winding.

Indeed, the continuous (or quasi-continuous) conduction of both of the halves of the secondary side winding implies that each half of the secondary side winding conducts continuously and in a bipolar (bidirectional) manner, thus leading to waveform(s) with low harmonic content.

The novel rectifier achieves also an excellent cross regulation of the two voltage outputs or rails, since one is built on top of the other and since, thanks to the two halves of the secondary side winding swapping in role every half cycle, there is no risk that one of the voltage outputs or rails can drift with respect to the other due to transformer unbalance.

Moreover, in case of usage of synchronous rectification, the rectifier components (transistors) are no more strictly unidirectional and will allows energy exchange and thus further voltage rebalance between the two capacitors and so between the two voltage outputs or rails.

Last but not least, being able to provide two voltage outputs or rails using a single center-tapped transformer and only four rectifier components (all having a volage rating equal to the value of the highest output), the novel rectifier is also quite cost effective.

According to an aspect of the disclosure, one or more of the rectifier components may be diodes.

This aspect has the advantage of simplifying the novel rectifier and thus reducing its cost.

According to another aspect of the disclosure, one or more of the rectifier components may be transistors.

This aspect has the advantage of allowing more sophisticated control and regulation of the novel rectifier.

Another embodiment of the disclosure provides an isolated or non-isolated power converter, for example a DC-DC power converter, comprising:
a switching circuit comprising at least one power switch configured to transform a direct voltage into a voltage wave, and
the novel rectifier delineated above, wherein the center-tapped transformer comprises a primary side winding coupled to receive the electric tension wave from the switching circuit.

This embodiment takes advantage of the novel rectifier, thereby achieving essentially the same benefit.

According to an aspect of this embodiment, the power converter may comprise a reactive circuit set up to achieve a ZVS (Zero Voltage Switching) of the power switch.

Thanks to this solution, the switching circuit can generate a voltage wave at higher frequency with low power losses.

According to another aspect, the reactive circuit may include a LLC resonant tank configured to filter the voltage wave generated by the switching circuit before it reaches the primary side winding of the center-tapped transformer.

In this way, the input excitation of the rectifier can be extremely close to a sine wave, thereby reducing the harmonic stress both in the primary and in the secondary side winding of the center-tapped transformer.

As an alternative, the reactive circuit may include a resonant tank of a class-E amplifier, configured to filter the voltage wave generated by the switching circuit before it reaches the primary side winding of the center-tapped transformer.

Another aspect of this embodiment may provide for the power converter to further comprise a primary side rectifier configured to convert an alternating voltage into a direct voltage to be applied to the switching circuit, and possibly a power factor correction circuit.

With this primary side rectifier, the power converter may advantageously assume the configuration of an AC/DC power converter.

### BRIEF DESCRIPTION OF THE FIGURES

The present invention will now be described, by way of example, with reference to the accompanying drawings.

FIG. 1 is a scheme of a rectifier according to an embodiment of the invention, shown during a positive half cycle.

FIG. 2 is the scheme of the rectifier of FIG. 1, shown during a negative half cycle.

FIG. 3 is a schematic representation of a converter including the rectifier of FIG. 1.

FIGS. 4 and 5 shows the current flowing in the two halves of the secondary side winding of a conventional center-tapped rectifier and of the rectifier of FIG. 1 respectively.

### DETAILED DESCRIPTION

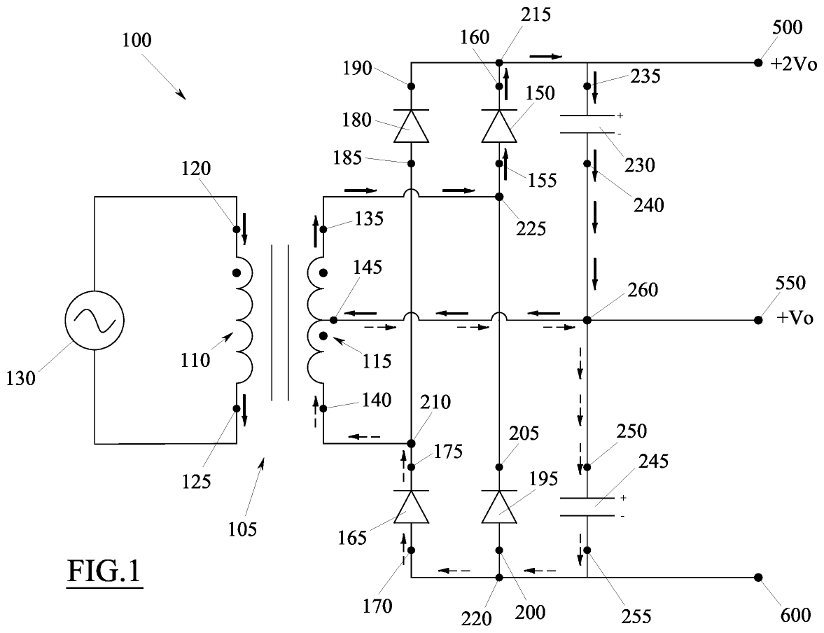

The rectifier 100 of FIG. 1 comprises a transformer 105 having a primary side winding 110 and a secondary side winding 115, which may be wound on a single core of magnetic material.

The primary side winding 110 comprises a first end terminal 120 and a second end terminal 125, which may be generally coupled to the opposite terminals of an AC voltage input 130.

The secondary side winding 115 comprises a first end terminal 135 a second end terminal 140 and a central terminal 145 which is connected across the middle point of the secondary side winding 115.

In this way, the transformer 105 assumes the topology of a so-called “center-tapped transformer”.

The rectifier 100 further comprises multiple rectifier components.

In this disclosure, each rectifier components is intended to as an electrical component which comprises at least two terminals, including a first terminal (also referred to as “anode”) and a second terminal (also referred to as “cathode”), and is capable of allowing electric current to flow from the anode to the cathode, while preventing a reverse flow of electric current from the cathode to the anode.

In the example illustrated in the figures, each one of the rectifier components is embodied as a diode.

However, in other embodiments, one or more (or each one) of the rectifier components may be embodied as a thyristor (e.g. Silicon Controlled Rectifier or SCR) or as a transistor, preferably as a field-effect transistor, such as for example IGBT, JFET, MOSFET or HEMT.

This component (i.e. the transistor) may have three terminals, including a source, a drain and a gate.

In the present disclosure, the source may be considered as the anode of the transistor while the drain may be considered as the cathode.

By applying an electrical tension to the gate of the transistor, the latter is brought in a first operational condition (saturation condition) in which electrical current is allowed to flow across the component, i.e. to flow between the source (anode) and the drain (cathode), whereas the removal of such electrical tension brings the transistor in a second operational condition (interdiction condition) that prevents electrical current from flowing across the component.

As a consequence, through a proper control of the electrical tension at the gate, it is advantageously possible to operate the transistor in such a way to emulate a diode or a thyristor.

Getting back to the rectifier 100, the rectifier components belonging thereto may include a first rectifier component 150 having the anode 155 connected to the first end terminal 135 of the secondary side winding 115 and the cathode 160 connected to a first output terminal 500 of the rectifier 100.

In should be observed that, in the present disclosure, the term “connected” may indicate that two terminals coincide with each other or are linked by a single electrical conductor (e.g. wire) or by multiple conductors leading to a common electrical node, so that they may be substantially at the same voltage, with preferably no other electrical components (such as switches, diodes, capacitors, resistors, inductors, etc.) interposed between them.

The rectifier components may further include a second rectifier component 165 having the anode 170 connected to a second output terminal 600 of the rectifier 100 and the cathode 175 connected to the second end terminal 140 of the secondary side winding 115 of the center-tapped transformer 105.

The rectifier components may further include a third rectifier component 180 and a fourth rectifier component 195.

The third rectifier component 180 has the anode 185 connected to a first common node 210 between the cathode 175 of the second rectifier component 165 and the second end terminal 140 of the secondary side winding 115, and the cathode 190 connected to a second common node 215 between the cathode 160 of the first rectifier component 150 and the first output terminal 500 of the rectifier 100.

It should be observed that, in the present disclosure, a “common node between two or more terminals” is intended to as an electrical node which these terminals are connected to in the sense explained above, namely an electrical node coinciding with these terminals or connected thereto by electrical conductors, so that they may be all substantially at the same voltage, preferably without other electrical components (e.g. switches, diodes, capacitors, resistors, inductors, etc.) in between.

The fourth rectifier component 195 has the anode 200 connected to a third common node 220 between the anode 170 of the second rectifier component 165 and the second output terminal 600 of the rectifier 100, and the cathode 205 connected to a fourth common node 225 between the anode 155 of the first rectifier component 150 and the first end terminal 135 of the secondary side winding 115 of the center-tapped transformer 105.

In practice, the first, second, third and fourth rectifier components 150, 165, 180 and 195 are arranged in a full-bridge configuration.

The rectifier 100 further comprises a reactive leg made of capacitors, which includes a first capacitor 230 and a second capacitor 245.

The first capacitor 230 has a first end terminal 235 connected to the second common node 215 and a second end terminal 240 connected to a fifth common node 260 between the central terminal 145 of the secondary side winding 115 of the center-tapped transformer 105 and a third output terminal 550 of the rectifier 100.

The second capacitor 245 has a first end terminal 250 connected to the fifth common node 260 and a second end terminal 255 connected to third common node 220.

Turning now to the output terminals of the rectifier 100, the second output terminal 600 of the rectifier 100 may be referred to a reference electrical voltage (for example but not necessarily to ground), whereas the first and the third output terminals 500 and 550 may be connected to a respective electrical load (not shown).

In other words, a first electrical load may be connected in series between the first output terminal 500 and the second output terminal 600, whereas a second electrical load may be connected in series between the third output terminal 550 and the second output terminal 600.

The operation of the rectifier 100 is described hereafter.

During the positive half cycle of the electrical voltage generated by the AC voltage input 130, the current at the primary side winding 110 of the center-tapped transformer 105 flows as indicated by the arrows in FIG. 1.

This way, the secondary side winding 115 produces a positive voltage at the first end terminal 135, a reference (e.g. zero) voltage at the second end terminal 140 and an intermediate voltage at the central terminal 145, which is equal to substantially half the sum of the voltages at the end terminals 135 and 140.

In practice, assuming V_{P} as the voltage difference between the first and the second end terminals 120 and 125 of the primary side winding 110, the voltage difference V_{A} between the first end terminal 135 and the central terminal 145 of the secondary side winding 115, and the voltage difference V_{B} between the central terminal 145 and the second end terminal 140, may be given by the following equations:

$${V}_{A} = \frac{{N}_{A}}{{N}_{P}} * {V}_{P}$$

$${V}_{B} = \frac{{N}_{B}}{{N}_{P}} * {V}_{P}$$

wherein N_{P} is the number of turns of the primary side winding 110, N_{A} is the number of turns of the secondary side winding 115 between the central terminal 145 and the first end terminal 135, and N_{B} is the number of turns of the secondary side winding 115 between the central terminal 145 and the second end terminal 140. Since N_{A} is equal to N_{B} (the transformer 105 is indeed a center-tapped transformer), V_{A} turns out to be equal to V_{B} (let's say equal to V_{O}), with the consequence that the first end terminal 135 may be referred to a positive voltage +2V_{O}, the second end terminal 140 may be referred to a null (zero) voltage, and the central terminal 145 may be referred to a positive voltage +V_{O}.

In this situation, the first rectifier component 150 allows (or is controlled to allow) electrical current to flow between the anode 155 and the cathode 160 (e.g. the diode is forward biased or the transistor is kept in saturation condition), whereas the third rectifier component 180 prevents (or is controlled to prevent) electrical current from flowing from the cathode 190 to the anode 185 (e.g. the diode is reverse biased or the transistor is kept in interdiction condition).

This makes a first close path for the electrical current from the first end terminal 135 to the central terminal 145 of the secondary side winding 115, thereby passing through the first capacitor 230 as indicated by the straight arrows in FIG. 1.

At the same time, the second rectifier component 165 allows (or is controlled to allow) electrical current to flow between the anode 170 and the cathode 175 (e.g. the diode is forward biased or the transistor is kept in saturation condition), whereas the fourth rectifier component 195 prevents (or is controlled to prevent) electrical current from flowing from the cathode 205 to the anode 200 (e.g. the diode is reverse biased or the transistor is kept in interdiction condition).

This makes a second close path for the electrical current from the central terminal 145 to the second end terminal 140 of the secondary side winding 115, thereby passing through the second capacitor 245 as indicated by the dotted arrows in FIG. 1.

In this way, both the first capacitor 230 and the second capacitor 245 are contemporaneously charged at a voltage difference equal to V_{O}.

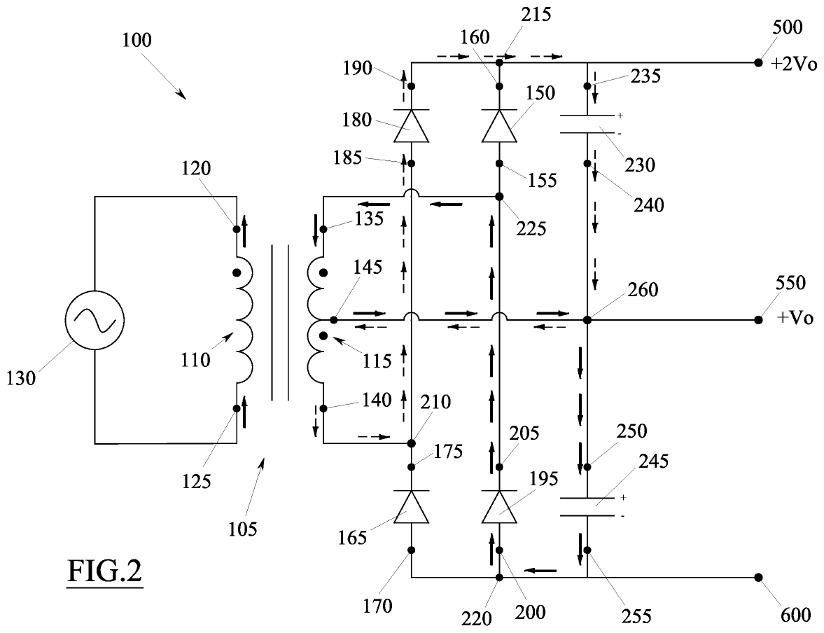

During the negative half cycle of the electrical voltage generated by the AC voltage input 130, the current at the primary side winding 110 of the center-tapped transformer 105 flows at the opposite, as indicated by the arrows in FIG. 2.

In this way, the secondary side winding 115 produces a negative voltage at the first end terminal 135, a reference (e.g. zero) voltage at the second end terminal 140 and an intermediate voltage at the central terminal 145 (e.g. negative), which is equal to the half of the sum of the voltages at the end terminals 135 and 140.

In practice the polarity across the secondary side winding 115 is reversed with respect to the positive half cycle described above.

In this situation, the first rectifier component 150 prevents (or is controlled to prevent) electrical current from flowing between the cathode 160 and the anode 155 (e.g. the diode is reverse biased or the transistor is kept in interdiction condition), whereas the third rectifier component 180 allows (or is controlled to allow) electrical current from flowing from the anode 185 to the cathode 190 (e.g. the diode is forward biased or the transistor is kept in saturation condition).

This makes a first close path for the electrical current from the second end terminal 140 to the central terminal 145 of the secondary side winding 115, thereby passing through the first capacitor 230 as indicated by the dotted arrows in FIG. 2.

At the same time, also the second rectifier component 165 prevents (or is controlled to prevent) electrical current from flowing between the cathode 175 and the anode 170 (e.g. the diode is reverse biased or the transistor is kept in interdiction condition), whereas the fourth rectifier component 195 allows (or is controlled to allow) electrical current to flow from the anode 200 to the cathode 205 (e.g. the diode is forward biased or the transistor is kept in saturation condition).

This makes a second close path for the electrical current from the central terminal 145 to the first end terminal 135 of the secondary side winding 115, thereby passing through the second capacitor 245 as indicated by the straight arrows in FIG. 2.

In this way, the polarity across the first capacitor 230 and the second capacitor 245 is still the same as in the positive half cycle described above and both of them are still contemporaneously charged at a voltage difference equal to V_{O}.

In view of the above, using the single center-tapped transformer 105, the rectifier 100 is effectively able to provide two voltage outputs or rails, represented for example by the first output terminal 500 and by the third output terminal 550, wherein one of this voltage outputs is reliably the double of the other.

Indeed, the first output terminal 500 of the rectifier 100 effectively provides, for example to the load connected thereto, a rectified voltage equal to 2V_{O}, while the third output terminal 550 effectively provides, for example to the load connected thereto, a rectified voltage equal to V_{O}.

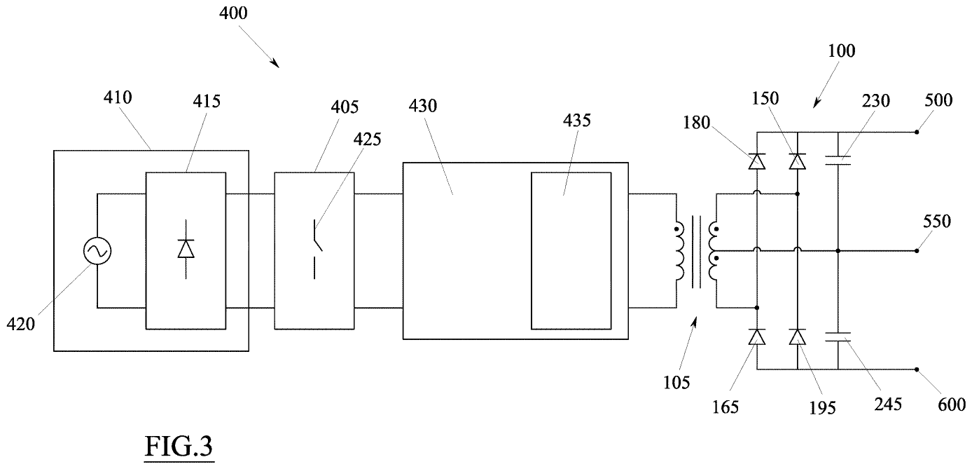

The rectifier 100 disclosed above may be advantageously (but not exclusively) included in an isolated or a non-isolated power converter 400, an example of which is schematically illustrated in FIG. 3.

In this case, the AC voltage input 130 may be embodied as (or replaced by) a switching circuit 405 configured to transform a direct electric voltage, provided for example by a DC voltage input 410, into an electric voltage wave.

In some embodiments, the DC voltage input 410 may be for example an electrical battery.

In other embodiments, the DC voltage input 410 may be a circuit including a primary side rectifier 415 configured to rectify an alternating voltage provided by an AC voltage input 420, thereby configuring the converter 400 as an AC/DC power converter.

The AC voltage input 420 may be any source of alternating voltage, for example a common electrical distribution grid (e.g. at 230V and 50 Hz), which the primary side rectifier 415 may be coupled to (e.g. through an electrical plug).

The primary side rectifier 415 may have any topology and/or configuration, for example but not exclusively diode bridge, single diode, coupled double diode, or any kind of synchronous rectifiers.

In addition, block 415 could also include a power factor correction circuit (PFC), either passive or active (e.g., but not limited to, a Boost PFC).

Turning now to the switching circuit 405, this circuit generally comprises at least one power switch 425, for example a transistor (e.g. BJT bipolar junction transistor, FET field effect transistor, MOSFET, MESFET, JFET, IGBT, HEMT or others), and a driver for applying to the power switch 425 an electrical pilot signal capable of turning it on (i.e. bring it in the saturation condition) and off (i.e. bring it in the interdiction condition).

For example, the switching circuit 405 may be embodied as a class-D, class-E, halfbridge, full-bridge or any other topology of AC/DC switching converters with any number of power switches 425.

The switching circuit 405 may be coupled to apply the generated voltage wave to the primary side winding 110 of the rectifier 100, directly or through one or more reactive circuits.

For example, in order to generate a high frequency voltage wave with low power losses, the converter 400 may include a reactive circuit 430, for example a resonant or fully resonant circuit, which is set up to achieve a ZVS (Zero Voltage Switching) of the power switch 425.

In other words, the reactive circuit 430 may be set up to lower the voltage or current stress applied to the power switch (switches) 425 in proximity to all or some of the switching events (transition of the power switch 425 from the interdiction condition to the saturation condition and vice versa), for example achieving full or partial ZVS or ZCS.

The reactive circuit 430 may be further set up to lower (or eventually to bring at substantially zero) also the time derivative of voltage or current applied to the power switch 425, any time the power switch 425 is switched from the interdiction condition to the saturation condition and vice versa.

By means of these strategies, the power losses of the switch (switches) 425 are positively reduced.

The reactive circuit 430 may include (or be embodied as) a LLC resonant tank 435 configured to receive the square voltage waveform generated by the switching circuit 405 and to output a sinusoidal (or almost sinusoidal) voltage waveform that is applied to the primary side winding 110 of the center-tapped transformer 105.

In other words, the LLC resonant tank 435 and the reactive circuit 430 may be embodied as a single circuit.

As an alternative, the resonant tank 435 may be that of a class-E amplifier, configured to filter the voltage wave generated by the switching circuit 405 before it reaches the primary side winding 110 of the center-tapped transformer 105.

Depending on the specific topology of the converter 400, the rectifier components 150, 165, 180 and 195 (if embodied as transistors) may be driven in ideal-diode fashion or with gate signals synchronous to the converter operation.

In any case, the use of the rectifier 100 in the converter 400, as well as in any other electrical circuit or device, entails several advantages.

For example, the rectifier 100 makes it possible to achieve a maximum utilization of the secondary side winding 115 of the center-tapped transformer 105, as both the two halves of the secondary side winding 115 are conducting current during every operation phase (i.e. both during positive and negative half cycles).

The fact that the two halves of the secondary side winding 115 are continuously conducting leads to extremely low harmonic stress in the secondary side winding 115, particularly with respect to conventional center-tapped rectifier.

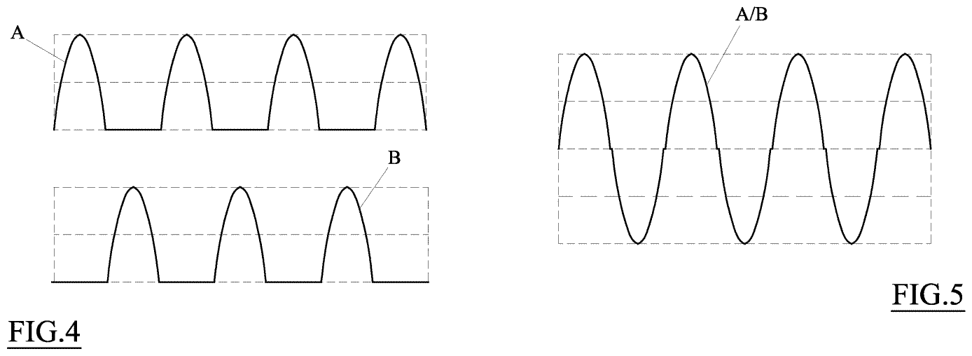

In this regard, reference could be made to the graph of FIG. 4, which shows the current flowing in the two halves of the secondary side winding of a conventional centertapped rectifier, and to the graph of FIG. 5, which shows the current flowing in the two halves of the secondary side winding 115 of the rectifier 100.

Both these graphs are made considering an input excitation of the primary side winding extremely close to a sine wave (e.g. if the rectifier is used in a resonant converter, e.g. with LLC resonant tank) or to a trapezoidal wave (e.g. if the rectifier is used in a conventional converter, e.g. without LLC resonant tank or the like).

As shown in FIG. 4, in case of the classical center-tapped rectifier, the two halves of the secondary side winding conduct impulsively and in a unipolar manner (curves A and B), with high harmonic content.

In case of the rectifier 100 (see FIG. 5), the quasi-continuous conduction of both of the halves of the secondary side winding 115 implies that each of them conducts continuously and in a bipolar manner, and thus with low harmonic content.

Moreover, the fact that both halves of the secondary side winding 115 (swapping in role every half cycle) are used to rectify energy for both voltage outputs or rails, the rectifier 100 shows low sensitivity to transformer secondary unbalance.

The rectifier 100 shows also an excellent cross regulation of the two voltage outputs or rails, since one is built on top of the other and since, thanks to the two halves of the secondary side winding 115 swapping in role every half cycle, there is no risk that one of the voltage outputs or rails can drift with respect to the other due to transformer unbalance.

Moreover, in case of usage of synchronous rectification, the rectifier components (transistors) 150, 165, 180 and 195 are no more strictly unidirectional and will allow energy exchange and thus further voltage rebalance between the two capacitors 230 and 245 and thus between the two voltage outputs or rails.

Last but not least, being able to provide two voltage outputs or rails using a single center-tapped transformer 105 and only four rectifier components 150, 165, 180 and 195, the rectifier 100 turns out to be quite cost effective.

This is also due to the fact that all the rectifier components 150, 165, 180 and 195 have a volage rating (breakdown voltage) that is substantially equal or slightly higher than the maximum output voltage (2V_{O}). As a comparison, traditional solutions, such as for example classic center-tapped rectifiers, require the rectifier components to have a voltage rating (breakdown voltage) that is often greater than twice the highest output (2*2V_{O}).

As an example, the presented rectifier has application in the frequency range of 50 KHz to 300 KHz. However, its adaptability extends to other implementations, potentially covering a broader spectrum from 20 KHz to 2 MHz.

Using the rectifier topology, a significant reduction in the size of power transformers compared to traditional implementations can be achieved, such as approximately 40% reduction in size.

While at least one or more exemplary embodiments have been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents.

1. A rectifier comprising:
a center-tapped transformer having a secondary side winding comprising a first terminal, a second terminal and a central terminal rectifier components, each of which comprises an anode, a cathode and is suitable for allowing electric current to flow from the anode to the cathode while preventing a reverse flow of electric current from the cathode to the anode, and capacitors,
wherein the rectifier components include:
a first rectifier component having the anode connected to the first terminal of the secondary side winding of the center-tapped transformer and the cathode connected to a first output terminal of the rectifier,
a second rectifier component having the anode connected to a second output terminal of the rectifier and the cathode connected to the second terminal of the secondary side winding of the centertapped transformer, a third rectifier component having the anode connected to a first common node between the cathode of the second rectifier component and the second terminal of the secondary side winding of the center-tapped transformer and the cathode connected to a second common node: between the cathode of the first rectifier component and the first output terminal of the rectifier, a fourth rectifier component having the anode connected to a third common node between the anode of the second rectifier component and the second output terminal of the rectifier and the cathode connected to a fourth common node between the anode of the first rectifier component and the first terminal of the secondary side winding of the center-tapped transformer, and
wherein the capacitors include:
a first capacitor having a first terminal connected to the second common node and a second terminal connected to a fifth common node between the central terminal of the secondary side winding of the center-tapped transformer and a third output terminal of the rectifier, and
a second capacitor having a first terminal connected to the fifth common node and a second terminal connected to third common node.

2. The rectifier according to claim 1, wherein one or more of the rectifier components is/are diodes.

3. The rectifier according to claim 1, wherein one or more of the rectifier components is/are transistors.

4. A power converter comprising:
a switching circuit comprising at least one power switch configured to transform a direct voltage into a voltage wave, and
the rectifier according to claim 1, wherein the center-tapped transformer comprises a primary side winding coupled to receive the voltage wave from the switching circuit.

5. The power converter according to claim 4, comprising a reactive circuit set up to achieve a ZVS of the power switch.

6. The power converter according to claim 5, wherein the reactive circuit includes a LLC resonant tank configured to filter the voltage wave generated by the switching circuit before it reaches the primary side winding of the center-tapped transformer.

7. The power converter according to claim 5, wherein the reactive circuit includes a resonant tank of a class amplifier, configured to filter the voltage wave generated by the switching circuit before it reaches the primary side winding of the center-tapped transformer.

8. The power converter according to claim 4, further comprising a primary side rectifier configured to convert an alternating voltage into a direct voltage to be applied to the switching circuit, and possibly a power factor corrector circuit.
